(19) United States
(12) Patent Application Publication
(10) Pub. No.: US 2012/0038765 A1
(43) Pub. Date: Feb. 16, 2012

(54) OBJECT SENSING SYSTEM AND METHOD FOR CONTROLLING THE SAME

(76) Inventors: Chun-Jen Lee, New Taipei City (TW); Cheng-Kuan Chang, Taipei City (TW); Yu-Chih Lai, Taipei City (TW); Chao-Kai Mao, Taichung City (TW); Wei-Che Sheng, Taipei City (TW); Hua-Chun Tsai, Taipei City (TW)

(21) Appl. No.: 13/172,869

(22) Filed: Jun. 30, 2011

(30) Foreign Application Priority Data
Aug. 11, 2010 (TW) 099126731

(51) Int. Cl. H04N 7/18

(52) U.S. Cl. 348/135; 348/E07.085

(57) ABSTRACT

An object sensing system includes an indication plane, a first image sensing unit, a plurality of light emitting units and a processing unit. The indication plane is used for an object to indicate a position. The first image sensing unit is disposed at a first corner of the indication plane. The light emitting units are disposed around the indication plane. Each of the light emitting units is corresponding to at least one of a plurality of operation times, at least one exposure time is set within each of the operation times, and each exposure time is corresponding to at least one of the light emitting units. The processing unit controls the light emitting units to emit light according to each exposure time correspondingly and controls the first image sensing unit to sense a first image relative to the indication plane within each operation time.

### BACKGROUND OF THE INVENTION

1. Field of the Invention

The invention relates to an object sensing system and method for controlling the same and, more particularly, to an object sensing system and method capable of effectively enhance sensing accuracy.

2. Description of the Prior Art

As touch technology advances, an electronic device with large size and multi-touch function will be widely used in daily life. Compared with other touch design, such as a resistive touch design, a capacitive touch design, an ultrasonic touch design, or a projective touch design, an optical touch design has the advantage of lower cost and is easier to use.

Referring to FIG. 1, FIG. 1 is a schematic diagram illustrating an optical touch system 1 of the prior art. As shown in FIG. 1, the optical touch system 1 comprises an indication plane 10, two image sensing units 12a, 12b, three light emitting units 14a, 14b, 14c, and a processing unit 16. The image sensing units 12a, 12b are disposed at opposite corners of the indication plane 10 respectively. The light emitting units 14a, 14b, 14c are disposed around the indication plane 10. The processing unit 16 is electrically connected to the image sensing units 12a, 12b and the light emitting units 14a, 14b, 14c. Each of the light emitting units 14a, 14b, 14c may be an independent light source (e.g. light emitting diode) or may consist of a light guide plate and a light source.

When the optical touch system 1 is being used, the processing unit 16 controls the light emitting units 14a, 14b, 14c to emit light simultaneously. When a user uses an object (e.g. a finger or stylus) to indicate a position on the indication plane 10, the object blocks part of light emitted by the light emitting units 14a, 14b, 14c. Afterward, the processing unit 16 controls the two image sensing units 12a, 12b to sense images relative to the indication plane 10. Then, the processing unit 16 determines a coordinate of the position indicated by the object or other information relative to the object according to the images sensed by the image sensing units 12a, 12b.

If the light emitting units 14a, 14b, 14c emit light simultaneously when the image sensing units 12a, 12b sense the images relative to the indication plane 10, light emitted by the light emitting units 14a, 14b, 14c will overlap and disturb each other. Consequently, the quality of the sensed images will be affected, the sensing accuracy will be reduced, and the electricity will be consumed much. Furthermore, if the light emitting units 14a, 14b, 14c emit light simultaneously and the light emitting times are the same, the illumination of some specific positions around the indication plane 10 will be so high or so low that the sensed image quality will be also affected and the sensing accuracy will be also reduced.

### SUMMARY OF THE INVENTION

Therefore, an objective of the invention is to provide an object sensing system and method capable of effectively enhance sensing accuracy.

According to one embodiment, an object sensing system of the invention comprises an indication plane, a first image sensing unit, a plurality of light emitting units and a processing unit. The indication plane is used for an object to indicate a position. The first image sensing unit is disposed at a first corner of the indication plane. The light emitting units are disposed around the indication plane. Each of the light emitting units is corresponding to at least one of a plurality of operation times, at least one exposure time is set within each of the operation times, and each exposure time is corresponding to at least one of the light emitting units. The processing unit is electrically connected to the first image sensing unit and the light emitting units. The processing unit controls the light emitting units to emit light according to each exposure time correspondingly and controls the first image sensing unit to sense a first image relative to the indication plane within each operation time.

According to another embodiment, a method of the invention for controlling the aforesaid object sensing system comprises steps of: relating each of the light emitting units to be corresponding to at least one of a plurality of operation times; setting at least one exposure time within each of the operation times, wherein each exposure time is corresponding to at least one of the light emitting units; and controlling the light emitting units to emit light according to each exposure time correspondingly and controlling the first image sensing unit to sense a first image relative to the indication plane within each operation time.

As mentioned in the above, the object sensing system and controlling method of the invention control each of the light emitting units to emit light according to the exposure time within each operation time and control the image sensing unit to sense an image relative to the indication plane within each operation time. In other words, the invention can adjust the exposure time of each light emitting unit individually according to different positions on the indication plane and the distance between each light emitting unit and the image sensing unit, so as to provide sufficient and stable illumination for the image sensing unit and enhance the image quality. Accordingly, the sensing accuracy of the object sensing system can be effectively enhanced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an optical touch system of the prior art.

FIG. 2 is a schematic diagram illustrating an object sensing system according to one embodiment of the invention.

FIG. 3 is a flowchart illustrating a method for controlling the object sensing system according to one embodiment of the invention.

FIG. 4 is sequence diagram illustrating the operation times and the exposure times according to one embodiment of the invention.

FIG. 5 is sequence diagram illustrating the operation times and the exposure times according to another embodiment of the invention.

FIG. 6 is sequence diagram illustrating the operation times and the exposure times according to another embodiment of the invention.

FIG. 7 is sequence diagram illustrating the operation times and the exposure times according to another embodiment of the invention.

FIG. 8 is sequence diagram illustrating the operation times and the exposure times according to another embodiment of the invention.

FIG. 9 is sequence diagram illustrating the operation times and the exposure times according to another embodiment of the invention.

FIG. 10 is a schematic diagram illustrating an object sensing system according to another embodiment of the invention.

FIG. 11 is a flowchart illustrating a method for controlling the object sensing system according to another embodiment of the invention.

FIG. 12 is a schematic diagram illustrating an object sensing system according to another embodiment of the invention.

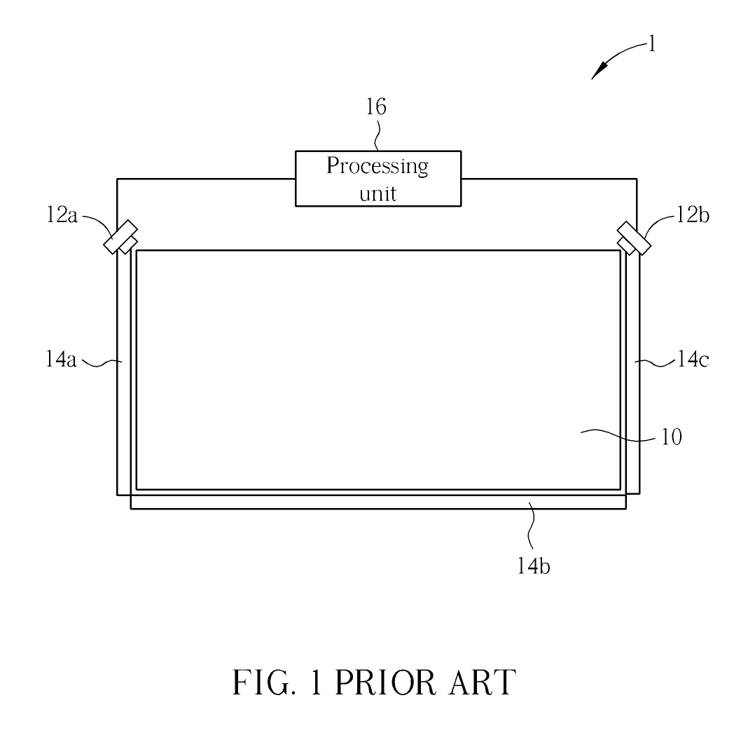

### DETAILED DESCRIPTION

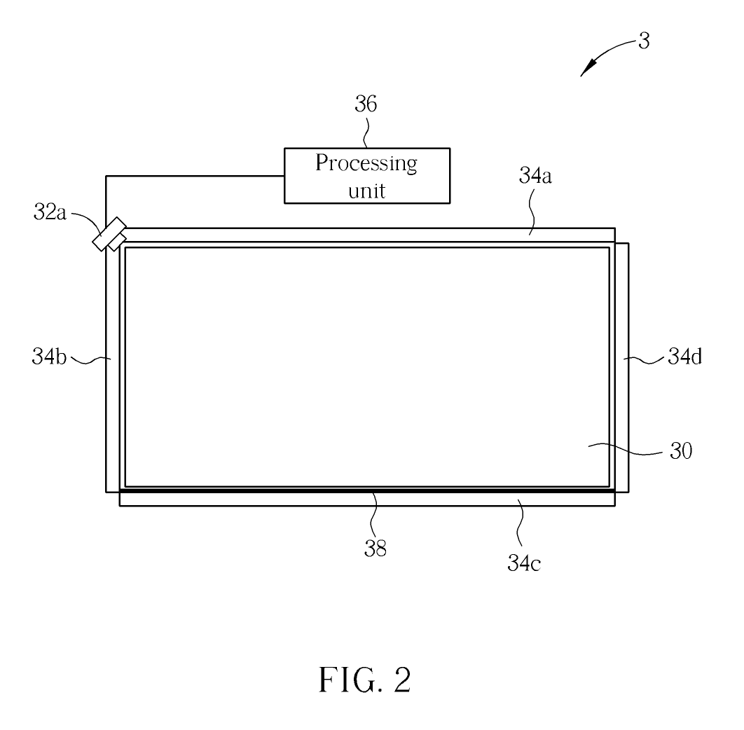

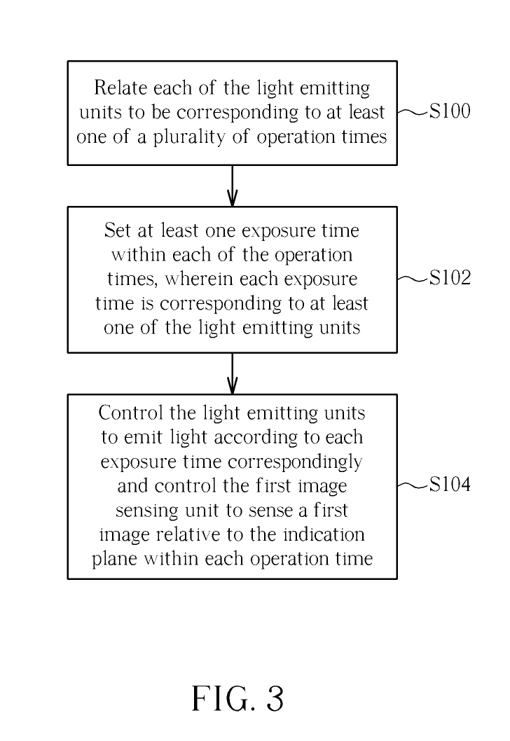

Referring to FIG. 2, FIG. 2 is a schematic diagram illustrating an object sensing system 3 according to one embodiment of the invention. As shown in FIG. 2, the object sensing system 3 comprises an indication plane 30, a first image sensing unit 32a, four light emitting units 34a, 34b, 34c, 34d, a processing unit 36 and a reflecting unit 38. The indication plane 30 is used for an object to indicate a position. The first image sensing unit 32a is disposed at a first corner of the indication plane 30. The light emitting units 34a, 34b, 34c, 34d are disposed around the indication plane 30. The reflecting unit 38 is also disposed around the indication plane 30 and located at the same side with the light emitting unit 34c. FIG. 2 is a top view of the object sensing system 3. In FIG. 2, the reflecting unit 38 and the light emitting unit 34c are substantially located at the same or very close position, meaning that the projection position of the reflecting unit 38 on the periphery of the indication plane 30 is substantially the same or very close to that of the light emitting unit 34c on the periphery of the indication plane 30. It should be noted that if the object sensing system 3 is observed from a side view, the reflecting unit 38 can be disposed above or under the light emitting unit 34c. The processing unit 36 is electrically connected to the first image sensing unit 32a and the light emitting units 34a, 34b, 34c, 34d. The reflecting unit 38 can be a flat mirror, a prism mirror, or other structures capable of reflecting light. Each of the light emitting units 34a, 34b, 34c, 34d may be an independent light source (e.g. light emitting diode) or may consist of a light guide plate and a light source. It should be noted that the number and arrangement of the light emitting units are not limited to the embodiment shown in FIG. 3 and those can be determined based on practical applications. The first image sensing units 32a can be a Charge-coupled Device (CCD) sensor or a Complementary Metal-Oxide Semiconductor (CMOS) sensor, or the like. The processing unit 36 can be a processor capable of calculating and processing data.

When the object sensing system 3 is being used, the processing unit 36 will control the light emitting units 34a, 34b, 34c, 34d to emit light individually during a predetermined polling time. When a user uses an object (e.g. a finger or stylus) to indicate a position on the indication plane 30, the object blocks part of light emitted by the light emitting units 34a, 34b, 34c, 34d. At the same time, the processing unit 36 controls the first image sensing unit 32a to sense a first image relative to the indication plane 30. Then, the processing unit 36 determines a coordinate of the position indicated by the object or other information relative to the object according to the first image sensed by the first image sensing unit 32a. In this embodiment, since there are four light emitting units 34a, 34b, 34c, 34d emitting light individually during the predetermined polling time, the first image sensing unit 32a will sense four first images relative to the indication plane 30 during the predetermined polling time. It should be noted that when the light emitting unit 34a or 34d emits light, the light emitted by the light emitting unit 34a or 34d can be reflected by the reflecting unit 38, so that the first image sensing unit 32a can sense a reflective image relative to the indication plane 30, wherein the aforesaid first image comprises this reflective image. Furthermore, the aforesaid predetermined polling time represents the needed time for polling the position coordinate indicated by the object every time by the processing unit 36. For example, if the frequency for the processing unit 36 to poll the position coordinate indicated by the object is set as 125 times per second, the needed time for polling the position coordinate indicated by the object every time by the processing unit 36 is equal to eight micro-seconds (i.e. the predetermined polling time).

In this embodiment, the aforesaid predetermined polling time can be divided into four operation times according to the number of light emitting units, wherein each of the light emitting units 34a, 34b, 34c, 34d is corresponding to at least one of the four operation times. At least one exposure time is set within each of the operation times and each exposure time is corresponding to at least one of the light emitting units 34a, 34b, 34c, 34d. The processing unit 36 controls the light emitting units 34a, 34b, 34c, 34d to emit light according to each exposure time correspondingly and controls the first image sensing unit 32a to sense a first image relative to the indication plane 30 within each operation time. It should be noted that when the object sensing system 3 is booting, the exposure time of each operation time can be adjusted automatically according to pixel noise, needed image quality and other factors of the first image sensing unit 32a. The aforesaid adjustment can be implemented by software design and it will not be depicted herein.

Referring to FIG. 3, FIG. 3 is a flowchart illustrating a method for controlling the object sensing system 3 according to one embodiment of the invention. Please refer to FIG. 3 along with FIG. 2. The controlling method of the invention comprises the following steps. First of all, step S100 is performed to relate each of the light emitting units 34a, 34b, 34c, 34d to be corresponding to at least one of a plurality of operation times. Afterward, step S102 is performed to set at least one exposure time within each of the operation times, wherein each exposure time is corresponding to at least one of the light emitting units 34a, 34b, 34c, 34d. Finally, step S104 is performed to control the light emitting units 34a, 34b, 34c, 34d to emit light according to each exposure time correspondingly and control the first image sensing unit 32a to sense a first image relative to the indication plane 30 within each operation time.

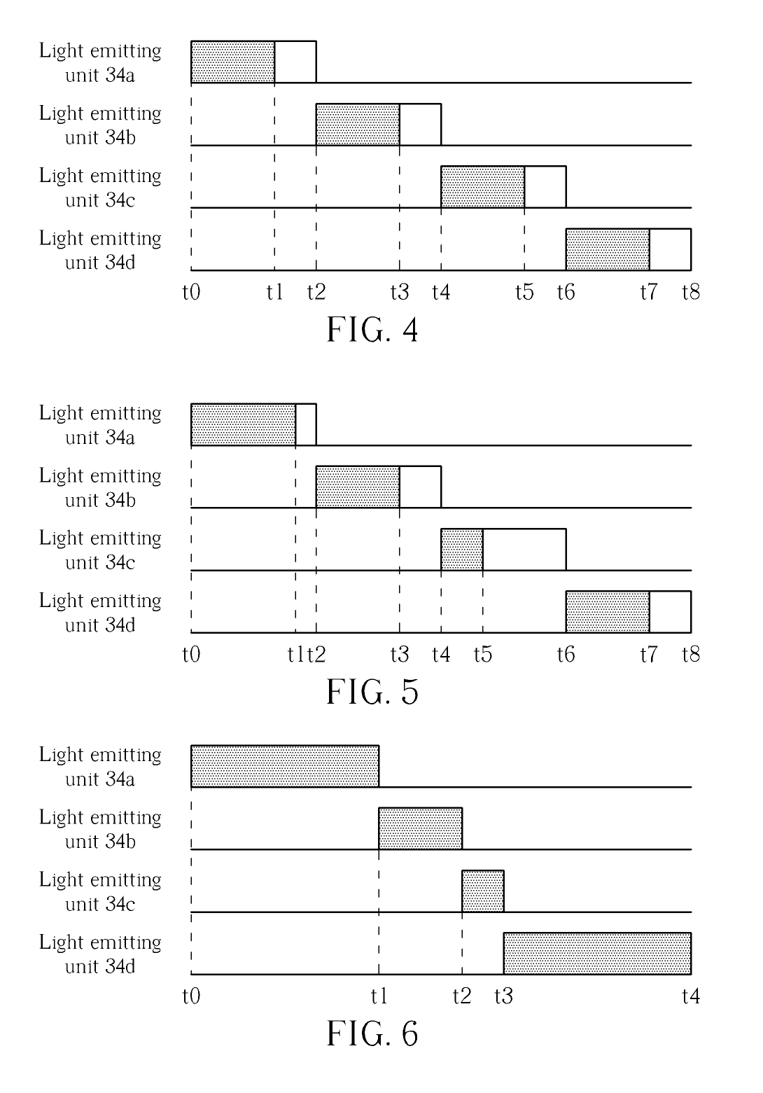

Referring to FIG. 4, FIG. 4 is sequence diagram illustrating the operation times and the exposure times according to one embodiment of the invention. As shown in FIG. 4, the predetermined polling time is set as t0-t8. In this embodiment, the predetermined polling time t0-t8 is divided into four operation times t0-t2, t2-t4, t4-t6, t6-t8 averagely according to the number of the light emitting units 34a, 34b, 34c, 34d, and four exposure times t0-t1, t2-t3, t4-t5, t6-t7 are set within the four operation times t0-t2, t2-t4, t4-t6, t6-t8 respectively. The four exposure times t0-t1, t2-t3, t4-t5, t6-t7 are shorter than the four operation times t0-t2, t2-t4, t4-t6, t6-t8 respectively. In this embodiment, all of the operation times t0-t2, t2-t4, t4-t6, t6-t8 are equal to each other and do not overlap each other, and all of the exposure times t0-t1, t2-t3, t4-t5, t6-t7 are equal to each other. In this embodiment, the processing unit 36 controls each of the light emitting units 34a, 34b, 34c, 34d to emit light according to each of the exposure times t0-t1, t2-t3, t4-t5, t6-t7 correspondingly and controls the first image sensing unit 32a to sense a first image relative to the indication plane 30 within each of the operation times t0-t2, t2-t4, t4-t6, t6-t8.

Referring to FIG. 5, FIG. 5 is sequence diagram illustrating the operation times and the exposure times according to another embodiment of the invention. As shown in FIG. 5, the predetermined polling time is set as t0-t8. In this embodiment, the predetermined polling time t0-t8 is divided into four operation times t0-t2, t2-t4, t4-t6, t6-t8 averagely according to the number of the light emitting units 34a, 34b, 34c, 34d, and four exposure times t0-t1, t2-t3, t4-t5, t6-t7 are set within the four operation times t0-t2, t2-t4, t4-t6, t6-t8 respectively. The four exposure times t0-t1, t2-t3, t4-t5, t6-t7 are shorter than the four operation times t0-t2, t2-t4, t4-t6, t6-t8 respectively. In this embodiment, all of the operation times t0-t2, t2-t4, t4-t6, t6-t8 are equal to each other and do not overlap each other, and at least one of the exposure times t0-t1, t2-t3, t4-t5, t6-t7 is unequal to other exposure times. As shown in FIG. 5, the exposure time t2-t3 is equal to the exposure time t6-t7 and is unequal to other exposure times t0-t1, t4-t5. In this embodiment, the processing unit 36 controls each of the light emitting units 34a, 34b, 34c, 34d to emit light according to each of the exposure times t0-t1, t2-t3, t4-t5, t6-t7 correspondingly and controls the first image sensing unit 32a to sense a first image relative to the indication plane 30 within each of the operation times t0-t2, t2-t4, t4-t6, t6-t8.

Referring to FIG. 6, FIG. 6 is sequence diagram illustrating the operation times and the exposure times according to another embodiment of the invention. As shown in FIG. 6, the predetermined polling time is set as t0-t4. In this embodiment, the predetermined polling time t0-t4 is divided into four operation times t0-t1, t1-t2, t2-t3, t3-t4 according to the number of the light emitting units 34a, 34b, 34c, 34d, and four exposure times t0-t1, t1-t2, t2-t3, t3-t4 are set within the four operation times t0-t1, t1-t2, t2-t3, t3-t4 respectively. In other words, the four exposure times t0-t1, t1-t2, t2-t3, t3-t4 are equal to the four operation times t0-t1, t1-t2, t2-t3, t3-t4 respectively. In this embodiment, all of the operation times t0-t1, t1-t2, t2-t3, t3-t4 do not overlap each other, at least one of the operation times t0-t1, t1-t2, t2-t3, t3-t4 is unequal to other operation times, and at least one of the exposure times t0-t1, t1-t2, t2-t3, t3-t4 is unequal to other exposure times. As shown in FIG. 6, the operation time t0-t1 is equal to the operation time t3-t4 and is unequal to other operation times t1-t2, t2-t3, and the exposure time t0-t1 is equal to the exposure time t3-t4 and is unequal to other exposure times t1-t2, t2-t3. In this embodiment, the processing unit 36 controls each of the light emitting units 34a, 34b, 34c, 34d to emit light according to each of the exposure times t0-t1, t1-t2, t2-t3, t3-t4 correspondingly and controls the first image sensing unit 32a to sense a first image relative to the indication plane 30 within each of the operation times t0-t1, t1-t2, t2-t3, t3-t4.

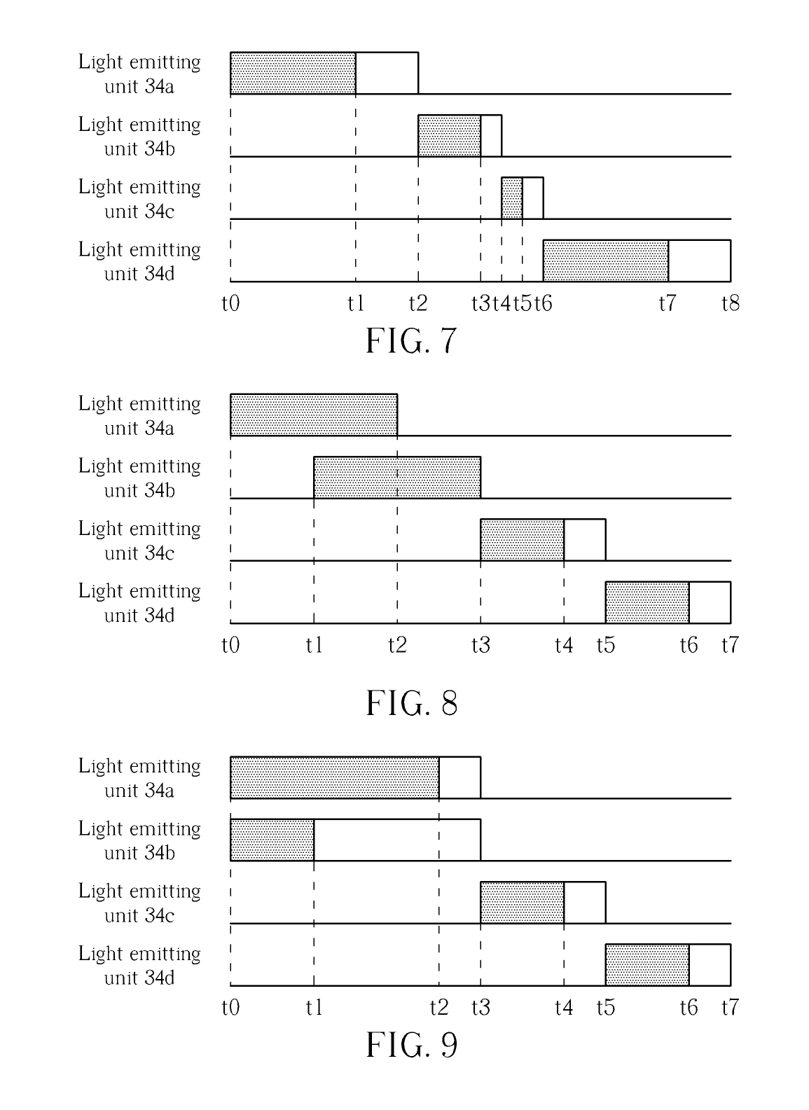

Referring to FIG. 7, FIG. 7 is sequence diagram illustrating the operation times and the exposure times according to another embodiment of the invention. As shown in FIG. 7, the predetermined polling time is set as t0-t8. In this embodiment, the predetermined polling time t0-t8 is divided into four operation times t0-t2, t2-t4, t4-t6, t6-t8 according to the number of the light emitting units 34a, 34b, 34c, 34d, and four exposure times t0-t1, t2-t3, t4-t5, t6-t7 are set within the four operation times t0-t2, t2-t4, t4-t6, t6-t8 respectively. The four exposure times t0-t1, t2-t3, t4-t5, t6-t7 are shorter than the four operation times t0-t2, t2-t4, t4-t6, t6-t8 respectively. In this embodiment, all of the operation times t0-t2, t2-t4, t4-t6, t6-t8 do not overlap each other, at least one of the operation times t0-t2, t2-t4, t4-t6, t6-t8 is unequal to other operation times, and at least one of the exposure times t0-t1, t2-t3, t4-t5, t6-t7 is unequal to other exposure times. As shown in FIG. 7, the operation time t0-t2 is equal to the operation time t6-t8 and is unequal to other operation times t2-t4, t4-t6, and the exposure time t0-t1 is equal to the exposure time t6-t7 and is unequal to other exposure times t2-t3, t4-t5. In this embodiment, the processing unit 36 controls each of the light emitting units 34a, 34b, 34c, 34d to emit light according to each of the exposure times t0-t1, t2-t3, t4-t5, t6-t7 correspondingly and controls the first image sensing unit 32a to sense a first image relative to the indication plane 30 within each of the operation times t0-t2, t2-t4, t4-t6, t6-t8.

Referring to FIG. 8, FIG. 8 is sequence diagram illustrating the operation times and the exposure times according to another embodiment of the invention. As shown in FIG. 8, the predetermined polling time is set as t0-t7. In this embodiment, the predetermined polling time t0-t7 is divided into four operation times t0-t2, t1-t3, t3-t5, t5-t7 according to the number of the light emitting units 34a, 34b, 34c, 34d, and four exposure times t0-t2, t1-t3, t3-t4, t5-t6 are set within the four operation times t0-t2, t1-t3, t3-t5, t5-t7 respectively. The exposure times t0-t2, t1-t3 are equal to the operation times t0-t2, t1-t3 respectively, and the exposure times t3-t4, t5-t6 are shorter than the operation times t3-t5, t5-t7 respectively. In this embodiment, at least two of the operation times t0-t2, t1-t3, t3-t5, t5-t7 at least partially overlap each other. As shown in FIG. 8, the operation times t0-t2, t1-t3 partially overlap each other and the overlapping portion is t1-t2. In this embodiment, the processing unit 36 controls each of the light emitting units 34a, 34b, 34c, 34d to emit light according to each of the exposure times t0-t2, t1-t3, t3-t4, t5-t6 correspondingly and controls the first image sensing unit 32a to sense a first image relative to the indication plane 30 within each of the operation times t0-t2, t1-t3, t3-t5, t5-t7.

In other words, according to pixel noise, needed image quality and other factors of the first image sensing unit 32a, if the illumination generated by the light emitting units 34a, 34b must be maximum, the operation times of the light emitting units 34a, 34b can be set to at least partially overlap each other, as shown in FIG. 8. Accordingly, the exposure times of the light emitting units 34a, 34b can be extended within the predetermined polling time so as to satisfy the illumination requirement.

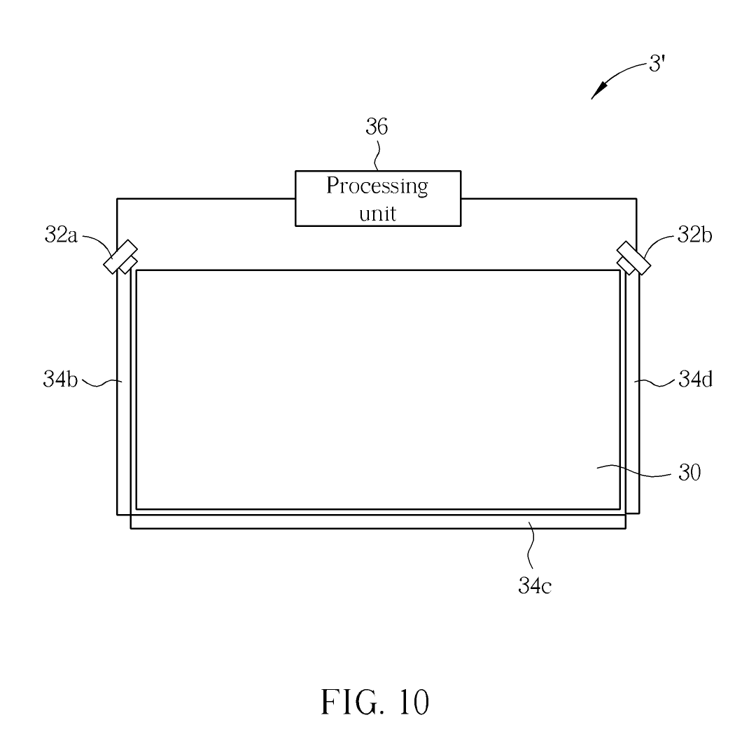

Referring to FIG. 9, FIG. 9 is sequence diagram illustrating the operation times and the exposure times according to another embodiment of the invention. As shown in FIG. 9, the predetermined polling time is set as t0-t7. In this embodiment, the predetermined polling time t0-t7 is divided into three operation times t0-t3, t3-t5, t5-t7. Two exposure times t0-t2, t0-t1 are set within the operation time t0-t3, and two exposure times t3-t4, t5-t6 are set within the operation times t3-t5, t5-t7 respectively. The exposure time t0-t2, t0-t1, t3-t4, t5-t6 are shorter than the operation times t0-t3, t3-t5, t5-t7 respectively. In this embodiment, the exposure times t0-t2, t0-t1 within the operation time t0-t3 at least partially overlap each other and are corresponding to different light emitting units 34a, 34b respectively, wherein the overlapping portion is t0-t1, as shown in FIG. 9. In this embodiment, the processing unit 36 controls each of the light emitting units 34a, 34b, 34c, 34d to emit light according to each exposure time t0-t2, t0-t1, t3-t4, t5-t6 correspondingly and controls the first image sensing unit 32a to sense a first image relative to the indication plane 30 within each operation time t0-t3, t3-t5, t5-t7.

Referring to FIG. 10, FIG. 10 is a schematic diagram illustrating an object sensing system 3′ according to another embodiment of the invention. As shown in FIG. 10, the main difference between the object sensing system 3′ and the aforesaid object sensing system 3 is that the object sensing system 3′ further comprises a second image sensing unit 32b electrically connected to the processing unit 36. The second image sensing unit 32b is disposed at a second corner of the indication plane 30, wherein the second corner is adjacent to the aforesaid first corner. In other words, the first and second image sensing units 32a, 32b are disposed at opposite corners of the indication plane 30. Furthermore, since the object sensing system 3′ is not equipped with the reflecting unit 38 shown in FIG. 2, the light emitting unit 34a shown in FIG. 2 can be removed accordingly. That is to say, the invention can be implemented in any object sensing system no matter the reflecting unit 38 shown in FIG. 2 is disposed therein or not. It should be noted that the components with identical labels in FIGS. 10 and 2 work substantially in the same way, so they will not be depicted herein again.

When the object sensing system 3′ is being used, the processing unit 36 will control the light emitting units 34b, 34c, 34d to emit light individually during a predetermined polling time. When a user uses an object (e.g. a finger or stylus) to indicate a position on the indication plane 30, the object blocks part of light emitted by the light emitting units 34b, 34c, 34d. At the same time, the processing unit 36 controls the first image sensing unit 32a to sense a first image relative to the indication plane 30 and controls the second image sensing unit 32b to sense a second image relative to the indication plane 30. Then, the processing unit 36 determines a coordinate of the position indicated by the object or other information relative to the object according to the first image sensed by the first image sensing unit 32a and/or the second image sensed by the second image sensing unit 32b. In this embodiment, since there are three light emitting units 34b, 34c, 34d emitting light individually during the predetermined polling time, the first image sensing unit 32a and the second image sensing unit 32b will sense three first images and three second images relative to the indication plane 30 respectively during the predetermined polling time.

It should be noted that since the object sensing system 3′ comprises only three light emitting units 34b, 34c, 34d, the aforesaid determined polling time in associated with FIGS. 4 to 9 can be divided into three operation times according to the number of the light emitting units 34b, 34c, 34d. Also, at least one exposure time can be set within each operation time appropriately in similar manner mentioned in the above. The division of the operation times and the setting of the exposure times are substantially the same as the description in associated with FIGS. 4 to 9 and they will not be depicted herein again.

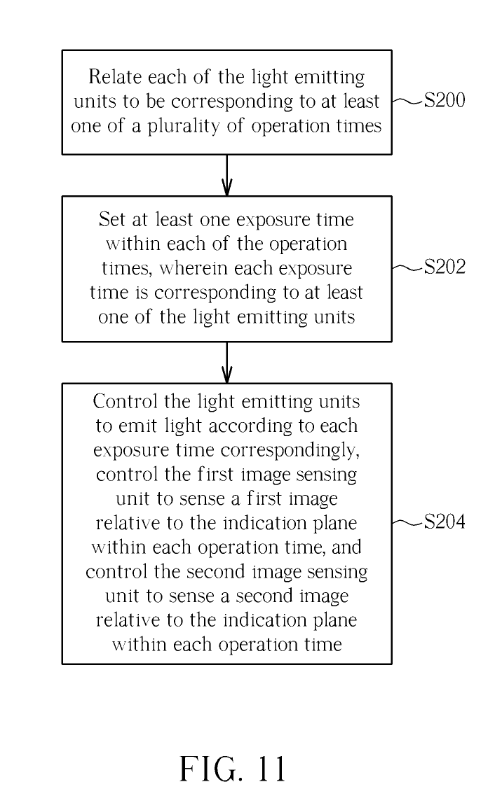

Referring to FIG. 11, FIG. 11 is a flowchart illustrating a method for controlling the object sensing system 3′ according to another embodiment of the invention. Please refer to FIG. 11 along with FIG. 10. The controlling method of the invention comprises the following steps. First of all, step S200 is performed to relate each of the light emitting units 34b, 34c, 34d to be corresponding to at least one of a plurality of operation times. Afterward, step S202 is performed to set at least one exposure time within each of the operation times, wherein each exposure time is corresponding to at least one of the light emitting units 34b, 34c, 34d. Finally, step S204 is performed to control the light emitting units 34b, 34c, 34d to emit light according to each exposure time correspondingly, control the first image sensing unit 32a to sense a first image relative to the indication plane 30 within each operation time, and control the second image sensing unit 32b to sense a second image relative to the indication plane 30 within each operation time.

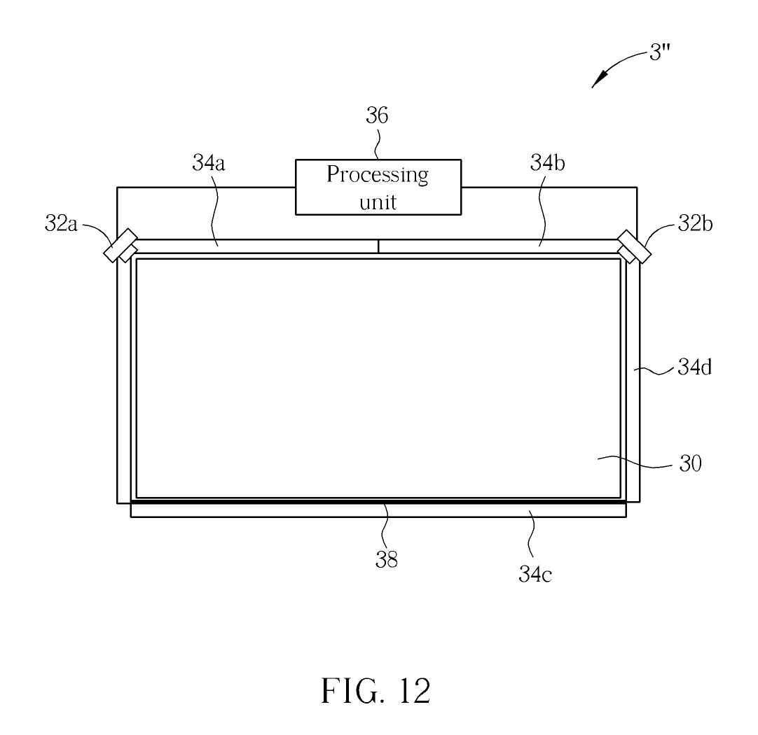

Referring to FIG. 12, FIG. 12 is a schematic diagram illustrating an object sensing system 3″ according to another embodiment of the invention. As shown in FIG. 12, the main difference between the object sensing system 3″ and the aforesaid object sensing system 3′ is that there are two light emitting units 34a, 34b disposed between the first image sensing unit 32a and the second image sensing unit 32b of the object sensing system 3″. Furthermore, the object sensing system 3″ further comprises a reflecting unit 38 disposed around the indication plane 30 and located at the same side with the light emitting unit 34c. Similar to FIG. 2, FIG. 12 is a top view of the object sensing system 3″. In FIG. 12, the reflecting unit 38 and the light emitting unit 34c are substantially located at the same or very close position, meaning that the projection position of the reflecting unit 38 on the periphery of the indication plane 30 is substantially the same or very close to that of the light emitting unit 34c on the periphery of the indication plane 30. It should be noted that if the object sensing system 3′ is observed from a side view, the reflecting unit 38 can be disposed above or under the light emitting unit 34c. The reflecting unit 38 can be a flat mirror, a prism mirror, or other structures capable of reflecting light. When the light emitting unit 34a, 34b or 34d emits light, the light emitted by the light emitting unit 34a, 34b or 34d can be reflected by the reflecting unit 38, so that the first image sensing unit 32a can sense a reflective image relative to the indication plane 30. It should be noted that the components with identical labels in FIGs. 12 and 10 work substantially in the same way, so they will not be depicted herein again.

According to pixel noise, needed image quality and other factors of the first image sensing unit 32a and the second image sensing unit 32b, if the illumination generated by the light emitting units 34a, 34b must be maximum when the object sensing system 3″ is being used, the operation times of the light emitting units 34a, 34b can be set to at least partially overlap each other, as shown in FIG. 8. Accordingly, the exposure times of the light emitting units 34a, 34b can be extended within the predetermined polling time so as to satisfy the illumination requirement.

As mentioned in the above, the object sensing system and controlling method of the invention control each of the light emitting units to emit light according to the exposure time within each operation time and control the image sensing unit to sense an image relative to the indication plane within each operation time. In other words, the invention can adjust the exposure time of each light emitting unit individually according to different positions on the indication plane and the distance between each light emitting unit and the image sensing unit, so as to provide sufficient and stable illumination for the image sensing unit and enhance the image quality. Furthermore, according to pixel noise, needed image quality and other factors of the image sensing unit, the invention can selectively make the operation times and/or exposure times at least partially overlap or not overlap each other and selectively make the operation times and/or exposure times be equal or unequal to each other, so as to satisfy different requirements of illumination and polling time. Accordingly, the sensing accuracy of the object sensing system can be effectively enhanced.

Those skilled in the art will readily observe that numerous modifications and alterations of the device and method may be made while retaining the teachings of the invention.

What is claimed is:

1. An object sensing system comprising:
an indication plane for an object to indicate a position;
a first image sensing unit disposed at a first corner of the indication plane;
a plurality of light emitting units disposed around the indication plane, each of the light emitting units being corresponding to at least one of a plurality of operation times, at least one exposure time being set within each of the operation times, each exposure time being corresponding to at least one of the light emitting units; and
a processing unit electrically connected to the first image sensing unit and the light emitting units, the processing unit controlling the light emitting units to emit light according to each exposure time correspondingly and controlling the first image sensing unit to sense a first image relative to the indication plane within each operation time.

2. The object sensing system of claim 1, wherein the exposure time is shorter than or equal to the corresponding operation time.

3. The object sensing system of claim. 1, wherein all of the operation times are equal to each other and do not overlap each other, and all of the exposure times are equal to each other.

4. The object sensing system of claim. 1, wherein all of the operation times are equal to each other and do not overlap each other, and at least one of the exposure times is unequal to other exposure times.

5. The object sensing system of claim 1, wherein all of the operation times do not overlap each other, at least one of the operation times is unequal to other operation times, and at least one of the exposure times is unequal to other exposure times.

6. The object sensing system of claim 1, wherein at least two of the operation times at least partially overlap each other.

7. The object sensing system of claim 1, further comprising a second image sensing unit electrically connected to the processing unit and disposed at a second corner of the indication plane, the second corner being adjacent to the first corner, the processing unit controlling the second image sensing unit to sense a second image relative to the indication plane within each operation time.

8. The object sensing system of claim 7, wherein at least two of the light emitting units are disposed between the first image sensing unit and the second image sensing unit, and at least two of the operation times, which are corresponding to the at least two of the light emitting units, at least partially overlap each other.

9. The object sensing system of claim 1, wherein a plurality of exposure times are set within at least one of the operation times, and the exposure times within the at least one of the operation times at least partially overlap each other and are corresponding to different light emitting units respectively.

10. A method for controlling an object sensing system, the object sensing system comprising an indication plane, a first image sensing unit and a plurality of light emitting units, the indication plane being used for an object to indicate a position, the first image sensing unit being disposed at a first corner of the indication plane, the light emitting units being disposed around the indication plane, the method comprising steps of:
relating each of the light emitting units to be corresponding to at least one of a plurality of operation times;
setting at least one exposure time within each of the operation times, each exposure time being corresponding to at least one of the light emitting units; and
controlling the light emitting units to emit light according to each exposure time correspondingly and controlling the first image sensing unit to sense a first image relative to the indication plane within each operation time.

11. The method of claim 10, wherein the exposure time is shorter than or equal to the corresponding operation time.

12. The method of claim 10, wherein all of the operation times are equal to each other and do not overlap each other, and all of the exposure times are equal to each other.

13. The method of claim 10, wherein all of the operation times are equal to each other and do not overlap each other, and at least one of the exposure times is unequal to other exposure times.

14. The method of claim 10, wherein all of the operation times do not overlap each other, at least one of the operation times is unequal to other operation times, and at least one of the exposure times is unequal to other exposure times.

15. The method of claim 10, wherein at least two of the operation times at least partially overlap each other.

16. The method of claim 10, wherein the object sensing system further comprises a second image sensing unit disposed at a second corner of the indication plane, the second corner is adjacent to the first corner, the method further comprises step of:
controlling the second image sensing unit to sense a second image relative to the indication plane within each operation time.

17. The method of claim 16, wherein at least two of the light emitting units are disposed between the first image sensing unit and the second image sensing unit, and at least two of the operation times, which are corresponding to the at least two of the light emitting units, at least partially overlap each other.

18. The method of claim 10, wherein a plurality of exposure times are set within at least one of the operation times, and the exposure times within the at least one of the operation times at least partially overlap each other and are corresponding to different light emitting units respectively.
